(19) United States
(12) Patent Application Publication
(10) Pub. No.: US 2005/0112369 A1
(43) Pub. Date: May 26, 2005

(54) Printed circuit board manufacture

(75) Inventors: Scott A. Ibbitson, Trappe, PA (US); Joseph R. Montano, Marlborough, MA (US); Jason A. Reese, Londonderry, NH (US); Robert V. Sloan, Ambler, PA (US)

Correspondence Address: EDWARDS & ANGELL, LLP, P.O. Box 55874, Boston, MA, 02205, US

(73) Assignee: Rohm and Haas Electronic Materials, L.L.C., Marlborough, MA (US)

(21) Appl. No.: 10/953,825

(22) Filed: Sep. 29, 2004

Related U.S. Application Data
(60) Provisional application No. 60/506,996, filed on Sep. 29, 2003.

(51) Int. Cl. B32B 3/00

(52) U.S. Cl. 428/344; 428/209; 428/343

(57) ABSTRACT

Methods of enhancing the adhesion between a metal surface and an organic polymeric material, such as a dielectric material, in the manufacture of printed circuit boards are provided. Such methods use an adhesion promoting composition including polymeric particles disposed between the metal surface and the organic polymeric material. Also provided are printed circuit boards having enhanced adhesion between a metal surface and an organic polymeric material.

### BACKGROUND OF THE INVENTION

This invention relates generally to the field of enhancing the adhesion between a metal surface and the surface of an organic polymeric material. In particular, this invention relates to the field of manufacturing printed circuit boards having enhanced adhesion between a metal surface and an organic polymeric material.

Multilayer printed circuit boards are used for a variety of electrical applications and provide the advantage of conservation of weight and space. A multilayer board is composed of two or more circuit layers, each circuit layer separated from another by one or more layers of dielectric material. The dielectric material is typically an organic polymeric material, such as epoxy and polyimide. Circuit layers are formed by applying a metal layer, such as a copper layer, onto a polymeric substrate. Printed circuits are then formed on the metal layers by techniques well known to the art, such as print and etch techniques, to define and produce the circuit traces, i.e., the discrete circuit lines in a desired circuit pattern. Once the circuit patterns are formed, a stack is formed containing multiple circuit layers separated from each other by one or more dielectric layers. Once the stack is formed, it is subjected to heat and pressure to form a laminated multilayer circuit board.

Following lamination, the multiple circuit layers are electrically connected to each other by drilling through-holes through the board surface. Resin smear from through-hole drilling is removed, for example, by treatment with a concentrated sulfuric acid or hot alkaline permanganate solution. Thereafter, the through-holes are further processed and metal plated to provide a conductive interconnecting surface.

Prior to lamination and through-hole formation, the discrete metal circuit lines are typically treated with an adhesion promoter to improve bond strength between each circuit layer and adjacent interleaving dielectric resin layers. One method used by the art to improve bond strength involves oxidative treatment of copper circuit lines to form a copper oxide surface coating on the circuit lines. The oxide coating is usually a black or brown oxide layer, typically referred to as “black oxide”, that adheres well to the copper. The oxide possesses significantly more texture or roughness than an untreated copper surface. Such chemically treated or roughened metal surface enhances adhesion of organic materials such as dielectrics to the copper. Other examples of such chemical treatments include metal phosphate coatings such as those used as paint adhesion promoters. The adhesion of organic materials to the roughened metal surface is believed to include mechanical interlocking between the metal surface and the organic material.

Such oxide process has certain drawbacks. The formation of the plated through-holes involves treatment with acidic materials. The acidic materials have a tendency to dissolve the copper oxide on the circuit lines where exposed in a through-hole, interfering with the bond between the circuit lines and the dielectric resin material and often causing a condition known in the art as “pink ring”. To reduce the susceptibility of the oxide to such attack, the oxide treatment described above is often followed by a step of converting the copper oxide to a form less soluble in acid while retaining enhanced surface roughness. Exemplary processes include reduction of the oxide by treatment with a reducing solution such as dimethylamine borane, an acid solution of selenium dioxide, or a sodium thiosulfate. An alternative approach involves partial or complete dissolution of the oxide layer to provide a copper surface having enhanced texture. Such additional steps add to the cost of the process and generate increased waste.

Another method for improving the adhesion of dielectric material to a copper circuit trace uses a microetching technique. Metal surfaces that have been microetched do not generally possess as high a degree of surface roughness and texture as those that have been treated by an oxide process. Exemplary microetching solutions are composed of hydrogen peroxide and an inorganic acid, such as sulfuric acid and phosphoric acid, and typically contain one or more corrosion inhibitors such as benzotriazole. While microetched copper surfaces greatly reduce the formation of pink ring, such microetched copper surfaces do not generally possess as high a degree of surface roughness and texture as those that have been treated by an oxide process. For certain organic materials, such as certain high Tg dielectric materials, such microetching may not provide sufficient adhesion between the copper traces and the dielectric material of a printed circuit board.

Still other techniques known in the art to promote adhesion between copper surfaces and dielectric resins prior to multilayer lamination include the use of etches inclusive of cupric chloride etchants, mechanical treatments designed to produce surface texture, and metal plating, all designed to produce roughened surfaces. Historically, mechanical treatment and chemical etching procedures have not generally found wide acceptance in the industry, most likely due to deficiencies in both process consistency and in the bond strength to the organic material. Electrolytic metal plating processes may provide highly roughened surfaces and are commonly used to enhance adhesion of continuous sheets of copper to epoxy for formation of copper circuit board laminates. However, the innerlayers of a printed circuit board contain many electrically discrete circuit traces which prevent use of a process requiring electrical connection to all areas to be plated.

International Patent Application WO 02/083328 (Landi et al.) discloses a method of enhancing the adhesion between a metal surface and the surface of a curable thermosetting composition by contacting the metal surface with an aqueous emulsion or dispersion of an elastomeric polymer, drying the aqueous emulsion or dispersion to form an adhesion promoting layer, contacting the adhesion promoting layer with a curable thermosetting composition and curing the thermosetting composition. The elastomeric polymers disclosed in this document function as cross-linkers with the thermosetting composition. Such elastomeric polymers themselves are linear polymers and are not cross-linked. The compositions containing the elastomeric polymer may also contain a variety of additives, such as fillers, wetting agents, surfactants, viscosity modifiers and the like. Such additives add cost to the process and may adversely affect the adhesion of the metal to the thermosetting composition, may provide an adhesion promoting layer having dielectric properties that are not similar to the thermosetting composition, and may lead to a coefficient of thermal expansion (“CTE”) mismatch between the adhesion promoting layer and the thermosetting composition. Such CTE mismatch will stress the printed circuit board during heating and cooling cycles. CTE mismatch concerns are more important for thick adhesion promoting coatings.

Accordingly, there remains a need for an adhesion promoting material and process that provides good adhesion between a metal surface and an organic polymeric material and meets the needs of industry, such as one or more of having less CTE mismatch with the organic polymeric material, having better formulating characteristics so as to reduce the need for additives in the adhesion promoting material composition, and having good insulating properties.

### SUMMARY OF THE INVENTION

Applicants have found that the adhesion of a metal surface to an organic polymeric material in the manufacture of a printed circuit board can be enhanced by the use of an adhesion promoting composition including polymeric particles.

The present invention provides a method for manufacturing a printed circuit board including the steps of: contacting a metal surface of a printed circuit board substrate with an adhesion promoting composition including polymeric particles having a mean particle diameter of 1 to 50 nm and comprising, as polymerized units, at least one multiethylenically unsaturated monomer and at least one ethylenically unsaturated monomer; and contacting the adhesion promoting composition with an organic polymeric material.

Also provided by the present invention is a printed circuit board including a metal surface and a layer of an adhesion promoting composition on at least a portion of the metal surface, the adhesion promoting composition including polymeric particles having a mean particle diameter of 1 to 50 nm and comprising, as polymerized units, at least one multiethylenically unsaturated monomer and at least one ethylenically unsaturated monomer.

The present invention provides increased adhesion of organic polymeric material to metal surfaces, particularly copper surfaces, without the need for pre-roughening the metal surface.

### DETAILED DESCRIPTION OF THE INVENTION

As used throughout this specification, the following abbreviations shall have the following meanings, unless the context clearly indicates otherwise: ° C.=degrees centigrade; Tg=glass transition temperature; g=gram; wt %=weight percent; Å=Angstrom; cm=centimeter; nm=nanometer; μm=micron=micrometer; μL=microliter; and mL=milliliter.

“Halogen” refers to fluorine, chlorine, bromine and iodine and “halo” refers to fluoro, chloro, bromo and iodo. Likewise, “halogenated” refers to fluorinated, chlorinated, brominated and iodinated. “Alkyl” includes linear, branched and cyclic alkyl. Likewise, “alkenyl” and “alkynyl” include linear, branched and cyclic alkenyl and alkynyl, respectively. The term “(meth)acrylic” includes both acrylic and methacrylic and the term “(meth)acrylate” includes both acrylate and methacrylate. Likewise, the term “(meth)acrylamide” refers to both acrylamide and methacrylamide. “Monomer” refers to a compound capable of being polymerized. The articles “a” and “an” refer to the singular and the plural.

Unless otherwise noted, all amounts are percent by weight and all ratios are molar ratios. All numerical ranges are inclusive and combinable in any order except where it is clear that such numerical ranges are constrained to add up to 100%.

The present invention provides printed circuit boards having enhanced adhesion between a metal surface and an organic polymeric material. Such enhanced adhesion is achieved through the use of an adhesion promoting composition including polymeric particles. Accordingly, the present invention provides a method for manufacturing a printed circuit board including the steps of: contacting a metal surface of a printed circuit board substrate with an adhesion promoting composition including polymeric particles having a mean particle diameter of 1 to 50 nm and comprising, as polymerized units, at least one multiethylenically unsaturated monomer and at least one ethylenically unsaturated monomer; and contacting the adhesion promoting composition with an organic polymeric material.

The polymeric particles, referred to herein sometimes as polymeric nanoparticles (“PNPs”), are addition polymers, which contain, as polymerized units, at least one multiethylenically unsaturated monomer and at least one ethylenically unsaturated water soluble monomer. Such multiethylenically unsaturated monomers, which function to cross-link the polymer particle, have multiple ethylenically unsaturated sites and function to cross-link the polymeric particles. Exemplary multiethylenically unsaturated monomers useful in the present invention include di-, tri-, tetra-, or higher multifunctional ethylenically unsaturated monomers, such as, for example, divinyl benzene (“DVB”), trivinylbenzene, divinyltoluene, divinylpyridine, divinylnaphthalene divinylxylene, ethyleneglycol di(meth)acrylate, trimethylolpropane trimethacrylate, trimethylolpropane triacrylate (“TMPTA”), diethyleneglycol divinyl ether, trivinylcyclohexane, allyl(meth)acrylate, diethyleneglycol di(meth)acrylate, propyleneglycol di(meth)acrylate, 2,2-dimethylpropane-1,3-di(meth)acrylate, 1,3-butylene glycol di(meth)acrylate, 1,4-butanediol di(meth)acrylate, 1,6-hexanediol di(meth)acrylate, tripropylene glycol di(meth)acrylate, triethylene glycol di(meth)acrylate, tetraethylene glycol di(meth)acrylate, polyethylene glycol di(meth)acrylates, such as polyethylene glycol 200 di(meth)acrylate and polyethylene glycol 600 di(meth)acrylate, ethoxylated bisphenol A di(meth)acrylate, poly(butanediol) di(meth)acrylate, pentaerythritol tri(meth)acrylate, trimethylolpropane triethoxy tri(meth)acrylate, glyceryl propoxy tri(meth)acrylate, pentaerythritol tetra(meth)acrylate, dipentaerythritol monohydroxypenta(meth)acrylate, divinyl silane, trivinyl silane, dimethyl divinyl silane, divinyl methyl silane, methyl trivinyl silane, diphenyl divinyl silane, divinyl phenyl silane, trivinyl phenyl silane, divinyl methyl phenyl silane, tetravinyl silane, dimethyl vinyl disiloxane, poly(methyl vinyl siloxane), poly(vinyl hydro siloxane), poly(phenyl vinyl siloxane), and mixtures thereof.

In general, the PNPs contain at least 1% by weight of at least one polymerized multiethylenically unsaturated monomer, based on the total weight of the PNPs. Up to and including 99.5 wt. % polymerized multiethylenically unsaturated monomer, based on the weight of the PNPs, is effectively used in the particles of the present invention. Typically, the multiethylenically unsaturated monomer is present in an amount of from 1% to 80%. Other exemplary amounts of the one or more multiethylenically unsaturated monomer are from 1% to 60%, and from 1% to 25%, by weight based on the total weight of the PNPs.

In addition to the multiethylenically unsaturated monomer, the PNPs further contain, as polymerized units, at least one ethylenically unsaturated monomer. Such ethylenically unsaturated monomers are typically monoethylenically unsaturated monomers. The amount of such ethylenically unsaturated monomers is at least 0.5 wt. %, based on the total weight of the PNPs. Up to and including 99 wt. % polymerized ethylenically unsaturated monomer, based on the weight of the PNPs, can be effectively used in the polymeric particles.

Any ethylenically unsaturated monomer is suitable for use in the present invention. Exemplary ethylenically unsaturated monomers include, without limitation, methacrylic acid (“MAA”), acrylic acid, (meth)acrylamides, (meth)acrylates including alkyl(meth)acrylates, alkenyl(meth)acrylates and aromatic (meth)acrylates, vinyl aromatic monomers, nitrogen-containing compounds and their thio-analogs, silyl-containing monomers, and substituted ethylene monomers.

Typically, the alkyl(meth)acrylates useful in the present invention are (C₁-C₂₄) alkyl(meth)acrylates. Suitable alkyl(meth)acrylates include, but are not limited to, “low cut” alkyl(meth)acrylates, “mid cut” alkyl(meth)acrylates and “high cut” alkyl(meth)acrylates.

“Low cut” alkyl(meth)acrylates are typically those where the alkyl group contains from 1 to 6 carbon atoms. Suitable low cut alkyl(meth)acrylates include, but are not limited to: methyl methacrylate (“MMA”), methyl acrylate, ethyl acrylate, propyl methacrylate, butyl methacrylate, butyl acrylate (“BA”), isobutyl methacrylate, hexyl methacrylate, cyclohexyl methacrylate, cyclohexyl acrylate and mixtures thereof.

“Mid cut” alkyl(meth)acrylates are typically those where the alkyl group contains from 7 to 15 carbon atoms. Suitable mid cut alkyl(meth)acrylates include, but are not limited to: 2-ethylhexyl acrylate (“2-EHA”), 2-ethylhexyl methacrylate, octyl methacrylate, decyl methacrylate, isodecyl methacrylate, undecyl methacrylate, dodecyl methacrylate (also known as lauryl methacrylate), tridecyl methacrylate, tetradecyl methacrylate (also known as myristyl methacrylate), pentadecyl methacrylate and mixtures thereof. Particularly useful mixtures include dodecyl-pentadecyl methacrylate, a mixture of linear and branched isomers of dodecyl, tridecyl, tetradecyl and pentadecyl methacrylates; and lauryl-myristyl methacrylate.

“High cut” alkyl(meth)acrylates are typically those where the alkyl group contains from 16 to 24 carbon atoms. Suitable high cut alkyl(meth)acrylates include, but are not limited to: hexadecyl methacrylate, heptadecyl methacrylate, octadecyl methacrylate, nonadecyl methacrylate, cosyl methacrylate, eicosyl methacrylate and mixtures thereof. Particularly useful mixtures of high cut alkyl(meth)acrylates include, but are not limited to: cetyl-eicosyl methacrylate, which is a mixture of hexadecyl, octadecyl, cosyl and eicosyl methacrylate; and cetyl-stearyl methacrylate, which is a mixture of hexadecyl and octadecyl methacrylate.

The mid-cut and high-cut alkyl(meth)acrylate monomers described above are generally prepared by standard esterification procedures using technical grades of long chain aliphatic alcohols, and these commercially available alcohols are mixtures of alcohols of varying chain lengths containing between 10 and 15 or 16 and 20 carbon atoms in the alkyl group. For the purposes of this invention, alkyl(meth)acrylate is intended to include not only the individual alkyl(meth)acrylate product named, but also to include mixtures of the alkyl(meth)acrylates with a predominant amount of the particular alkyl(meth)acrylate named.

The alkyl(meth)acrylate monomers useful in the present invention may be a single monomer or a mixture having different numbers of carbon atoms in the alkyl portion. Also, the (meth)acrylamide and alkyl(meth)acrylate monomers useful in the present invention may optionally be substituted. Suitable optionally substituted (meth)acrylamide and alkyl(meth)acrylate monomers include, but are not limited to: hydroxy (C₂-C₆)alkyl(meth)acrylates, dialkylamino(C₂-C₆)-alkyl(meth)acrylates, dialkylamino(C₂-C₆)alkyl(meth)acrylamides.

In one embodiment, useful substituted alkyl(meth)acrylate monomers are those with one or more hydroxyl groups in the alkyl radical, especially those where the hydroxyl group is found at the β-position (2-position) in the alkyl radical. Suitable hydroxyalkyl(meth)acrylate monomers include, but are not limited to: 2-hydroxyethyl methacrylate (“HEMA”), 2-hydroxyethyl acrylate, 2-hydroxypropyl methacrylate, 1-methyl-2-hydroxyethyl methacrylate, 2-hydroxy-propyl acrylate, 1-methyl-2-hydroxyethyl acrylate, 2-hydroxybutyl methacrylate, 2-hydroxybutyl acrylate and mixtures thereof.

Other substituted (meth)acrylate and (meth)acrylamide monomers useful in the present invention are those with a dialkylamino group or dialkylaminoalkyl group in the alkyl radical. Examples of such substituted (meth)acrylates and (meth)acrylamides include, but are not limited to: dimethylaminoethyl methacrylate, dimethylaminoethyl acrylate, N,N-dimethylaminoethyl methacrylamide, N,N-dimethyl-aminopropyl methacrylamide, N,N-dimethylaminobutyl methacrylamide, N,N-di-ethylaminoethyl methacrylamide, N,N-diethylaminopropyl methacrylamide, N,N-diethylaminobutyl methacrylamide, N-(1,1-dimethyl-3-oxobutyl)acrylamide, N-(1,3-diphenyl-1-ethyl-3-oxobutyl)acrylamide, N-(1-methyl-1-phenyl-3-oxobutyl)methacrylamide, and 2-hydroxyethyl acrylamide, N-methacrylamide of aminoethyl ethylene urea, N-methacryloxy ethyl morpholine, N-maleimide of dimethylaminopropylamine and mixtures thereof.

Still other substituted (meth)acrylate monomers useful in the present invention are glycidyl acrylate, glycidyl methacrylate (“GMA”), acetoacetate-functional (meth)acrylate monomers such as acetoacetoxyethyl acrylate and acetoacetoxyethyl methacrylate (“AAEM”) and silicon-containing monomers such as γ-propyl tri(C₁-C₆)alkoxysilyl(meth)acrylate, γ-propyl tri(C₁-C₆)alkylsilyl(meth)acrylate, γ-propyl di(C₁-C₆)alkoxy(C₁-C₆)alkylsilyl(meth)acrylate, γ-propyl di(C₁-C₆)alkyl(C₁-C₆)alkoxysilyl(meth)acrylate, vinyl tri(C₁-C₆)alkoxysilyl(meth)acrylate, vinyl di(C₁-C₆)alkoxy(C₁-C₆)alkylsilyl(meth)acrylate, vinyl (C₁-C₆)alkoxydi(C₁-C₆)alkylsilyl(meth)acrylate, vinyl tri(C₁-C₆)alkylsilyl(meth)acrylate, and mixtures thereof. One suitable silicon-containing (meth)acrylate is (trimethoxysilyl)propyl methacrylate (“MATS”).

The vinylaromatic monomers useful as unsaturated monomers in the present invention include, but are not limited to: styrene (“STY”), α-methylstyrene, vinyltoluene, p-methylstyrene, ethylvinylbenzene, vinylnaphthalene, vinylxylenes, and mixtures thereof. The vinylaromatic monomers also include their corresponding substituted counterparts, such as halogenated derivatives, i.e., containing one or more halogen groups, such as fluorine, chlorine or bromine; and nitro, cyano, (C₁-C₁₀)alkoxy, halo(C₁-C₁₀)alkyl, carb(C₁-C₁₀)alkoxy, carboxy, amino, and (C₁-C₁₀)alkylamino derivatives.

The nitrogen-containing compounds and their thio-analogs useful as unsaturated monomers in the present invention include, but are not limited to: vinylpyridines such as 2-vinylpyridine or 4-vinylpyridine; lower alkyl (C₁-C₈) substituted N-vinyl pyridines such as 2-methyl-5-vinyl-pyridine, 2-ethyl-5-vinylpyridine, 3-methyl-5-vinylpyridine, 2,3-dimethyl-5-vinyl-pyridine, and 2-methyl-3-ethyl-5-vinylpyridine; methyl-substituted quinolines and isoquinolines; N-vinylcaprolactam; N-vinylbutyrolactam; N-vinylpyrrolidone; vinyl imidazole; N-vinyl carbazole; N-vinyl-succinimide; (meth)acrylonitrile; o-, m-, or p-aminostyrene; maleimide; N-vinyl-oxazolidone; N,N-dimethyl aminoethyl-vinyl-ether; ethyl-2-cyano acrylate; vinyl acetonitrile; N-vinylphthalimide; N-vinyl-pyrrolidones such as N-vinyl-thio-pyrrolidone, 3 methyl-1-vinyl-pyrrolidone, 4-methyl-1-vinyl-pyrrolidone, 5-methyl-1-vinyl-pyrrolidone, 3-ethyl-1-vinyl-pyrrolidone, 3-butyl-1-vinyl-pyrrolidone, 3,3-dimethyl-1-vinyl-pyrrolidone, 4,5-dimethyl-1-vinyl-pyrrolidone, 5,5-dimethyl-1-vinyl-pyrrolidone, 3,3,5-trimethyl-1-vinyl-pyrrolidone, 4-ethyl-1-vinyl-pyrrolidone, 5-methyl-5-ethyl-1-vinyl-pyrrolidone and 3,4,5-trimethyl-1-vinyl-pyrrolidone; vinyl pyrroles; vinyl anilines; and vinyl piperidines.

Any ethylenically unsaturated silyl-containing monomer may be used in the present polymeric particles. Exemplary ethylenically unsaturated silyl-containing monomers include, but are not limited to, vinyltrimethylsilane; vinyltriethylsilane, vinyltrimethoxysilane, vinyltriethoxysilane, γ-trimethoxysilylpropyl(meth)acrylate, allyloxy-tert-butyldimethylsilane, allyloxytrimethylsilane, allyltriethoxysilane, allyltri-iso-propylsilane, allyltrimethoxysilane, allyltrimethylsilane, allyltriphenylsilane, diethoxy methylvinylsilane, diethyl methylvinylsilane, dimethyl ethoxyvinylsilane, dimethyl phenylvinylsilane, ethoxy diphenylvinylsilane, methyl bis(trimethylsilyloxy)vinylsilane, triacetoxyvinylsilane, triethoxyvinylsilane, triethylvinylsilane, triphenylvinylsilane, tris(trimethylsilyloxy)vinylsilane, vinyloxytrimethylsilane and mixtures thereof.

Exemplary substituted ethylene monomers include, but are not limited to: allylic monomers; vinyl acetate; vinyl formamide; vinyl chloride; vinyl fluoride; vinyl bromide; vinylidene chloride; vinylidene fluoride; vinylidene bromide; vinyl carboxylic acids such as itaconic acid, acryloxypropionic acid, and crotonic acid; dicarboxylic acid monomers, such as itaconic acid, maleic acid, fumaric acid, and citraconic acid and monomers which are half esters of dicarboxylic acids, such as monomers containing one carboxylic acid functionality and one C₁₋₆ ester, and vinyl anhydrides such as itaconic anhydride and maleic anhydride.

The ethylenically unsaturated monomer may be capable of bearing an ionic charge in an aqueous medium, such monomers are herein referred to as “ionic monomers”. Suitable ionic monomers include, for example, acid-containing monomers, base-containing monomers, amphoteric monomers; quaternized nitrogen-containing monomers, and other monomers that can be subsequently formed into ionic monomers, such as monomers which can be neutralized by an acid-base reaction to form an ionic monomer. Suitable acid groups include carboxylic acid groups and strong acid groups, such as phosphorus containing acids and sulfur containing acids. Suitable base groups include amines. Such ionic monomers may be useful when a water soluble or water dispersible PNP is desired. In such cases, the amount of polymerized ionic monomer based on the weight of the PNPs is typically in the range from 0.5 to 99 wt. %. More particularly, the ionic monomer may be present in the range of from 1 to 50 wt. %.

The PNPs may optionally contain one or more other functional groups. The functional groups may be present in the multiethylenically unsaturated monomer, the ethylenically unsaturated monomer and both types of monomers. Alternatively, the PNPs may be functionalized after polymerization to incorporate such functional groups. The functional group may be selected to improve adhesion to the metal surface, to the organic polymeric material, or to both. The choice of such functional groups will depend upon certain factors such as the level of adhesion desired between the metal surface and the organic polymeric material, the particular metal used and the particular organic polymeric material used.

For example, when the metal is copper, a functional group may be selected to improve adhesion to the copper, to reduce oxidation of the copper surface, or to accomplish both. Suitable functional groups for use with copper include, without limitation: nitrogen-containing moieties and in particular amines and nitrogen-containing heterocyclic moieties, such as nitrogen-containing heteroaromatic moieties; acid groups such as carboxylic acids; and epoxy groups such as glycidyl(meth)acrylate. Exemplary nitrogen-containing moieties include, but are not limited to, (meth)acrylamides, nitrile groups, and ureido groups. Exemplary nitrogen-containing heteroaromatic moieties include, without limitation, triazole, benzotriazole, substituted-benzotriazoles such as alkyl benzotriazoles and hydroxy benzotriazoles, tetrazole, substituted-tetrazole, imidazole, substituted-imidazole, and pyridine. Suitable acid-containing moieties include, without limitation, (meth)acrylic acid, itaconic acid, and maleic acid.

When the organic polymeric material is an epoxy resin, the PNPs may contain suitable functional groups, such as epoxy, hydroxy and acid groups, to improve the adhesion to the epoxy resin. For example, when an epoxy resin is to be applied to a copper surface, the PNPs used may contain both a functional group to enhance adhesion to copper, such as a triazole, and a group to enhance adhesion to the epoxy resin, such as a hydroxyl group. Epoxy-containing PNPs, such as PNPs including one or more glycidyl(meth)acrylates, may be capable of improving the adhesion to both the copper surface and to an epoxy-based organic polymeric material.

Alternatively, the PNPs may also function in certain cases as a release agent. For example, selecting PNPs that do not contain functional groups to improve the adhesion to the metal surface and to the organic polymeric material may provide easy removal of the organic polymeric material subsequent to the adhesion step.

In another embodiment, the PNPs may contain as polymerized units one or more poly(alkylene oxide) monomers. Exemplary poly(alkylene oxide) monomers include, but are not limited to, poly(propylene oxide) monomers, poly(ethylene oxide) monomers, poly(ethylene oxide/propylene oxide) monomers, poly(propylene glycol)(meth)acrylates, poly(propylene glycol)alkyl ether(meth)acrylates, poly(propylene glycol)phenyl ether(meth)acrylates, poly(propylene glycol) 4-nonylphenol ether(meth)acrylates, poly(ethylene glycol)(meth)acrylates, poly(ethylene glycol)alkyl ether(meth)acrylates, poly(ethylene glycol)phenyl ether(meth)acrylates, poly(propylene/ethylene glycol)alkyl ether(meth)acrylates and mixtures thereof. Preferred poly(alkylene oxide) monomers include trimethoylolpropane ethoxylate tri(meth)acrylate, trimethoylolpropane propoxylate tri(meth)acrylate, poly(propylene glycol)methyl ether acrylate, and the like. Particularly suitable poly(propylene glycol)methyl ether acrylate monomers are those having a molecular weight in the range of from 200 to 2000, such as poly(propylene glycol methyl ether acrylate having a molecular weight of approximaterly 260 (“PPGMEA 260”). The poly(ethylene oxide/propylene oxide) monomers useful in the present invention may be linear, block or graft copolymers. Such monomers typically have a degree of polymerization of from 1 to 50, and preferably from 2 to 50.

The PNPs useful in the present invention may be prepared by polymerizing the one or more multiethylenically unsaturated monomers and the one or more ethylenically unsaturated monomers. Any suitable polymerization technique may be used, such as solution polymerization and emulsion polymerization. Suitable solution polymerization methods are those disclosed in U.S. Pat. No. 5,863,996 (Graham) and U.S. Pat. No. 6,420,441 (Allen et al.) and U.S. Publication No. 20030008989 (Gore et al.). Suitable emulsion polymerization methods are disclosed in U.S. Pat. No. 6,420,441 (Allen et al.). The PNPs are typically prepared using anionic polymerization or free radical polymerization techniques.

In general, the PNPs have a mean diameter in the range of 1 to 50 nm, although PNPs having larger particle sizes my be used advantageously. More typically, the PNPs have a mean diameter in the range of 1 to 40 nm, still more typically from 1 to 30 nm, even more typically from 1 to 25 nm. Still other PNPs may have a mean diameter of 1 to 20 nm and still further from 1 to 10 nm. In one embodiment, the PNPs have a mean particle diameter of at least 1.5 nm, and more typically at least 2 nm. One method of determining the particle sizes (mean particle diameter) of the PNPs is by using standard dynamic light scattering techniques, wherein the correlation functions are converted to hydrodynamic sizes using LaPlace inversion methods, such as CONTIN. Control of PNP particle size and distribution is achieved by one or more of such methods as choice of solvent used in the polymerization, choice of initiator, total solids level, initiator level, type and amount of multiethylenically unsaturated monomer, type and amount of ethylenically unsaturated monomer, type and amount of chain transfer agent, and reaction conditions.

The PNPs of the present invention typically have an “apparent weight average molecular weight” in the range of 5,000 to 1,000,000, more typically from 10,000 to 500,000 and still more typically from 15,000 to 100,000. As used herein, “apparent weight average molecular weight” reflects the size of the PNP particles using standard gel permeation chromatography methods, e.g., using tetrahydrofuran solvent at 40° C., 3 Plgel™ Columns (Polymer Labs, Amherst, Mass.), 100 Å (10 nm), 10³ Å (100 nm), 10⁴ Å (1 μm), 30 cm long, 7.8 mm inner diameter, 1 mL per minute, 100 μL injection volume, calibrated to narrow polystyrene standards using Polymer Labs CALIBRE™ software.

The present adhesion promoting compositions contain PNPs and optionally one or more carriers. Suitable carriers include, without limitation, organic solvents, water, and a combination of water and organic solvents. Typically, the polymeric particles compose from 0.1 to 100 wt % of the adhesion promoting composition, based on a total dry weight of the adhesion promoting composition. Other suitable amounts of polymeric particles include from 1 to 90 wt %, from 1 to 85 wt % and from 5 to 50 wt %. In one embodiment, the PNPs compose ≦40 wt % of the adhesion promoting composition.

The adhesion promoting compositions may be solids or liquids. Such solid adhesion promoting compositions may be applied to the metal surface by any suitable means, such as by a melt, dry film, and a paste. When a dry film adhesion promoting composition is used, it may be applied using any conventional dry film techniques, such as those used in the dry film photoresist art, such as vacuum lamination. Melts may be applied by any suitable technique, such as by extrusion. Pastes may be applied by conventional techniques.

Suitable liquid adhesion promoting compositions may be solutions, dispersions, emulsions or any other suitable form. The PNPs are typically soluble in a wide variety of organic solvents. Exemplary organic solvents include, without limitation, alcohols, esters, glycols, glycol ethers, glycol ether esters, hydrocarbons, halodrydocarbons, aromatic hydrocarbons, ethers, ketones, lactones and mixtures thereof. Aqueous dispersions containing polymeric particles may be prepared by first preparing a non-aqueous PNP dispersion containing the PNPs dispersed in at least one solvent; and combining the non-aqueous PNP dispersion with an aqueous medium. The non-aqueous dispersion is suitably prepared by any of the solution polymerization methods discussed above for the formation of the polymeric particles. “Aqueous” as used herein refers to a composition containing ≧50 wt % water and the term “non-aqueous” refers to a composition containing <50 wt % water, based on the weight of the composition. Other suitable methods of preparing aqueous dispersions are well known to those skilled in the art. Adhesion promoting emulsion compositions can be prepared by emulsion polymerization of the monomers used to prepare the PNPs. Alternatively, the PNPs can be prepared by solution polymerization, the resulting product then being emulsified by the addition of appropriate surfactant(s) and water.

The PNPs can be used as a dispersion in the polymerization solvent or they can be isolated by, for example, vacuum evaporation, by precipitation into a non-solvent, and spray drying. When isolated, PNPs can be subsequently redispersed in a medium appropriate for the adhesion promoting composition. In one embodiment, the medium is water. Alternatively, the isolated PNPs could be redispersed directly into a water-based emulsion.

In another embodiment, the polymeric particle composition after polymerization is optionally treated to remove at least a portion of the solvent and/or water, to increase the solids content of the PNPs. Suitable methods to concentrate the PNPs include distillation processes, such as forming azeotropes of water and a suitable solvent; evaporation of solvent or water; drying the aqueous composition by freeze drying or spray drying; solvent extraction techniques; and ultrafiltration techniques. In this manner, at least a portion of the solvent and/or water is removed. Removal of the solvent is preferably carried out under conditions that minimize destabilization (i.e., flocculation) of the PNPs.

In a further embodiment, an aqueous adhesion promoting composition is prepared by a method including the steps of preparing a non-aqueous PNP dispersion containing the PNPs dispersed in at least one solvent that is both a suitable solvent for the PNPs and is compatible or miscible in water; and combining the non-aqueous PNP dispersion with an aqueous medium. Examples of such suitable solvents for acrylic-containing PNPs include isopropanol and ether alcohols, e.g., monobutyl ether of ethylene glycol and monoethyl ether of diethylene glycol.

While the preparation of the aqueous adhesion promoting compositions does not require the use of surfactants, and it is typical that the non-aqueous adhesion promoting compositions are substantially free of surfactants, surfactants are optionally included. When present, the amount of surfactants is typically less than 3 wt %, more typically less than 2 wt %, even more typically less than 1 wt %, further typically less than 0.5 wt. %, and even further typically less than 0.2 wt. %, based on total weight of the PNPs.

Such liquid adhesion promoting compositions may be applied by any suitable means such as by one or more of dip-coating, spray-coating, wash-coating, die-coating, curtain-coating, roller-coating and reverse roller-coating.

The present adhesion promoting compositions may optionally include one or more additives, such as but not limited to, flow aids, fillers, other polymers, surfactants and viscosity modifiers. Exemplary fillers include, without limitation, titanium dioxide (futile and anatase), barium titanate, strontium titanate, silica, including fused amorphous silica, corundum, wollastonite, aramide fibers (e.g., KEVLAR™ from DuPont), fiberglass, Ba₂Ti₉O₂₀, glass spheres, quartz, boron nitride, aluminum nitride, silicon carbide, beryllia, alumina, magnesia, and fumed silicon dioxide (e.g., Cab-O-Sil™, available from Cabot Corporation), used alone or in combination. The above named materials may be in the form of solid, porous, or hollow particles. Although such fillers are nor necessary, when used they are typically present in an amount of 1 to 40 parts per hundred, based on the weight of the PNPs.

In an alternate embodiment, the adhesion promoting compositions optionally include one or more epoxy compounds, additional polymers, oligomers, monomers and mixtures thereof. Suitable epoxy compounds are those containing one or more epoxide groups, and typically two or more epoxide groups. In general, such epoxy compounds may contain one or more ether linkages and even two or more ether linkages. Such epoxy compounds may also contain one or more hydroxy groups. Further, the epoxy compounds may contain one or more vinyl groups. In one embodiment, the epoxy compounds have a molecular weight of ≦10,000. Other suitable molecular weights are ≦5000, ≦3000, ≦2500, ≦1500 and ≦1000. A suitable range of molecular weight is from 100 to 10,000.

Such additional polymers may be linear polymers, dendrimers, star polymers, and the like, and may be homopolymers or copolymers. Exemplary additional polymers include, without limitation, elastomeric polymers such as those disclosed in WO 02/083328 (Landi et al.) and WO 03/020000 (Landi et al.). Suitable elastomeric polymers include, but are not limited to, ethylene-propylene elastomer, ethylene-propylene-diene monomer elastomer, styrene-butadiene elastomer, styrene butadiene block copolymers; 1,4-polybutadiene; other polybutadiene block copolymers such as styrene isoprene-styrene triblock, styrene-(ethylene-butylene)-styrene triblock, styrene-(ethylene-propylene)-styrene triblock, and styrene-(ethylene-I 15 butylene) diblock; polyisoprene; elastomeric acrylate homopolymers and copolymers; silicone elastomers; fluoropolymer elastomers; butyl rubber; urethane elastomers; norbornene and dicyclobutadiene based elastomers; butadiene copolymers with acrylonitrile, acrylate esters, methacrylate esters or carboxylated vinyl monomers; copolymers of isoprene with acrylonitrile, (meth)acrylate esters, carboxylated vinyl monomers; and mixtures thereof. The combination of PNPs with elastomeric polymers in the adhesion promoting composition improves the adhesion of organic polymeric material to metal as compared to the use of the elastomeric polymers alone.

An advantage of the present adhesion promoting compositions is that the PNPs may be self-dispersing, i.e. the PNPs also function as dispersants such that the presence of additional dispersing agents can be reduced or eliminated. The PNPs may also function as wetting agents, thus reducing or eliminating the need for additional wetting agents in the adhesion promoting compositions. Thus, the use of PNPs in the adhesion promoting composition reduces or eliminates the need for additional components. Such additional components may adversely affect the mechanical and/or insulating properties of the adhesion promoting composition. Further, such PNPs may further provide one or more properties improved relative to conventional adhesion promoting compositions: improved mechanical stability; improved adhesion; improved CTE match with the organic polymeric material; improved wetting of the metal surface, and reduced drying time.

The present adhesion promoting compositions improve the adhesion of a wide variety of organic polymeric materials to a wide variety of metal surfaces. In the manufacture of printed circuit boards, various metals may be resent on the surface of the printed circuit board. Such metals include, without limitation, one or more of copper, aluminum, tin, silver, gold, lead, zinc, nickel, and alloys thereof. Copper is particularly useful in the manufacture of printed circuit boards.

The metal surface may be composed of a number of metal layers, such as, but not limited to, tin on copper, tin-lead alloy on copper, silver on copper, gold on copper, and gold on nickel on copper. Copper, when deposited in the form of a foil, may optionally contain one or more coatings to provide a textured surface and/or to prevent oxidation of the copper. Such coatings include one or more of silane coatings, titanate coatings, and zincate coatings.

In an alternate embodiment, the metal surface may include one or more additional coatings, such as coatings of one or more of resistor materials, capacitor materials and both resistor materials and capacitor materials. Suitable resistor materials include, without limitation, those disclosed in European Patent Application No. 955 642 (Hunt et al.) and U.S. Patent Application Publication No. 20030121883 (Allen et al.). Suitable capacitor materials include, but are not limited to, those disclosed in U.S. Pat. No. 6,270,835 (Hunt et al.), U.S. Pat. No. 6,180,252 (Farrell et al.), U.S. Pat. No. 6,137,671 (Staffiere) and International Patent Application WO 01/67465 (Zou et al.).

Such metal may be free-standing or supported on a surface such as on a ceramic or may be disposed on a polymeric material. The metal may be also be a foil. Typically, the metal is disposed on a polymeric material. When disposed on a polymeric material or a ceramic, the metal may be patterned to provide circuit traces, including pads. Such patterning may be achieved by various processes well known in the art. For example, a photoresist is disposed on the surface of the metal. The photoresist is imaged using an appropriate wavelength of actinic radiation. The photoresist is then developed. In the case of a negative-acting photoresist, development reveals unwanted areas of metal. The unwanted areas are then removed, such as by etching. The photoresist is then removed to reveal the patterned metal.

A wide variety of organic polymeric materials may be used in the present invention. Exemplary organic materials may be solids or liquids and include, but are not limited to, organic polymeric dielectric materials, photoresists, and soldermasks. Exemplary solid organic polymeric materials include, without limitation, dry film photoresist, dry film soldermask, and prepreg. Particularly suitable organic polymeric materials include permanent soldermasks and dielectric materials (prepreg). In general, the organic polymeric material is further cured after it is contacted with the adhesion promoting composition. Such curing may be by heating or irradiation with actinic radiation. Typically, such curing is by heating, and more typically a combination of heat and pressure.

The organic polymeric material may be thermosetting or thermoplastic. Exemplary organic polymeric materials include, without limitation, epoxy resins, polyimide resins, polyester resins, polyarylene resins, polyarylene-ether resins, polybutadiene resins, bismaleimide-triazine resins, polyether-imide resins, cyanate ester resins, polyisoprene resins, and acrylate resins. It will be appreciated by those skilled in the art that a variety of mixtures of organic polymeric material may be advantageously used in the present invention. Such organic polymeric materials may have a wide variety of Tgs, such as from <100° C. to 210° C. or even greater. Suitable dielectric materials are available from a number of commercial sources, such as Rogers Corporation, Rogers, Conn.

In one embodiment, the metal surface of a printed circuit board substrate is contacted with the present adhesion promoting compositions. A layer of the adhesion promoting composition is thus disposed on at least a portion of the metal surface. Such adhesion promoting composition layer may optionally be dried, if a liquid adhesion promoting composition is used, or may be used as is. In one embodiment, the present invention provides a printed circuit board including a metal surface and a layer of an adhesion promoting composition on at least a portion of the metal surface, the adhesion promoting composition comprising polymeric particles having a mean particle diameter of 1 to 50 nm and comprising, as polymerized units, at least one multiethylenically unsaturated monomer and at least one ethylenically unsaturated monomer. The layer of adhesion promoting composition may then contacted with an organic polymeric material, and in particular a dielectric material.

In an alternate embodiment, a solid organic polymeric material is contacted with the present adhesion promoting composition such that a layer of the adhesion promoting composition is disposed on at least a portion of the organic polymeric material. Such adhesion promoting composition layer may optionally be dried, if a liquid adhesion promoting composition is used, or may be used as is. The layer of adhesion promoting composition is then contacted with a metal surface of a printed circuit board substrate.

Typically, the printed circuit board substrate is subjected to conditions sufficient to adhere the organic polymeric material to the metal surface. Such adherence is typically achieved by lamination. Typical lamination conditions subject the printed circuit board substrate to heat and pressure for a period of time to bond the layers and optionally cure the organic polymeric material. The particular temperature and pressure will depend upon the particular printed circuit board substrate and the organic material selected, and are readily ascertainable by one of ordinary skill in the art.

In an alternate embodiment, the PNPs are added to the organic polymeric material, thus reducing or eliminating the need for an adhesion promoting composition disposed between a metal surface and the organic polymeric material. For example, PNPs could be blended with an organic polymeric material, the blend then being formed into a prepreg. Such PNP-containing prepreg is then contacted with a cleaned metal surface and then subjected to conditions sufficient to adhere the organic polymeric material to the metal surface, typically lamination conditions.

The present invention generally provides improved adhesion, as measured by peel strength, of organic polymeric materials to metal surfaces following lamination as compared to processes that laminate an organic polymeric material directly to a metal surface. Such peel strengths are determined by peeling a 0.5 inch (1.25 cm) wide strip of foil from the organic polymeric material using an Instron instrument. The peel strength is averaged over a 1-2 inch (2.5 to 5 cm) extension, and is measured in pound-force per inch (lbf/in; 1 lbf/in=0.18 kg/cm) using the software supplied with the Instron instrument. It will be appreciated by those skilled in the art that not every PNP will improve the adhesion of every organic material to each metal surface. Thus, one PNP may improve the adhesion of a first organic polymeric material to a first metal surface, but may not improve the adhesion of a second organic polymeric material to the first metal surface. Likewise, such PNP may not improve the adhesion of the first organic polymeric material to a second metal surface. The amount of adhesion improvement will depend upon the particular PNP selected, the particular organic polymeric material selected and the particular metal surface selected.

Conventional methods to improve the adhesion of metal surfaces to organic polymeric material in the manufacture of printed circuit boards use various roughening (texturing) techniques which provide topography on the metal surface. For example, copper surfaces are conventionally microetched to provide a rough copper surface to provide enhanced mechanical locking with the organic polymeric material. The present invention provides for improved adhesion without the need for such a roughening step, i.e. using a smooth metal surface. Alternatively, the present adhesion promoting compositions and processes can be used to improve the adhesion of metal surfaces that are roughened.

The following examples are expected to illustrate further various aspects of the present invention, but are not intended to limit the scope of the invention in any aspect.

### EXAMPLE 1

Preparation of Butyl Acrylate PNPs. A 5 liter reactor is fitted with a thermocouple, a temperature controller, a purge gas inlet, a water-cooled reflux condenser with purge gas outlet, a stirrer, and an addition funnel. To the addition funnel is charged 571.5 g of a monomer mixture consisting of 337.5 g butyl acrylate (100% purity), 67.5 g acrylic acid (100% purity), 45 g trimethylol propane triacrylate, 9 g of a 75% solution of t-amyl peroxypivalate in mineral spirits (Luperox 554-M-75), and 112.5 g isopropyl alcohol (“IPA”). The reactor, containing 2334 g IPA is then flushed with nitrogen for 30 minutes before applying heat to bring the contents of the reactor to 75° C. When the contents of the reactor reached 75° C., the monomer mixture in the addition funnel is then uniformly charged to the reactor over 90 minutes. Thirty minutes after the end of the monomer mixture addition, the first of two chaser aliquots, spaced thirty minutes apart and consisting of 9.0 g of a 75% solution of t-amyl peroxypivalate in mineral spirits (Luperox 554-M-75) and 23 g IPA, is added. At the end of the second chaser aliquot, the contents of the reactor are held 2½ hours at 80° C. to complete the reaction. The resulting polymer is then isolated removal of solvent in vacuo. This material is alkaline water. The PNPs thus formed have a particle size distribution of from 2.8 to 3.6 nm as determined by GPC.

### EXAMPLE 2

Copper foils are taped to a carrier. The exposed copper face is microetched to clean the copper surface, which removed approximately 20 μin. (0.5 μm) of copper, using a conventional horizontal cleaning line as follows. The exposed copper foil is first sprayed with an acid cleaner and then rinsed with deionized (“DI”) water. Next, the copper foil is contacted with a commercially available sodium persulfate-based microetch followed by a DI water rinse. The copper is then contacted with a 2% sulfuric acid solution followed by a DI water rinse and drying with hot air.

The microetched copper foils are cut into 5×4 inch (13×10 cm) coupons. The coupons are then dipped into 2% sulfuric acid and rinsed with DI water. The foils are then dipped into an adhesion promoting composition containing one or more PNPs and allowed to dry.

The foils containing the adhesion promoting composition layer are then laminated to an epoxy prepreg material (FR 406 prepreg) using conventional lamination conditions of heat and pressure.

The adhesion of the prepreg to the copper foil is evaluated by determining the peel strength. Such peel strengths are determined by peeling a 0.5 inch (1.25 cm) wide strip of foil from the prepreg using an Instron instrument. The peel strength is averaged over a 1-2 inch (2.5 to 5 cm) extension, and is measured in pound-force per inch (lbf/in; 1 lbf/in=0.18 kg/cm) using the software supplied with the Instron instrument.

PNPs evaluated are reported in Table 1 along with the peel strengths determined. The control is a copper foil treated in the same manner as all other copper foils except that it is not coated with an adhesion promoting composition. The mean particle size reported is the mean particle diameter as determined by light scattering. The adhesion promoting composition used are 15% solids except for samples G and H which are 30% solids.

TABLE 1

| | | Mean Particle | Peel Strength |
|---|---|---|---|
| Sample | PNP | Size (nm) | (lbf-in) |
| Control | None | — | 0.9 |
| A | 2-EHA/DVB/GMA (90/5/5) | 3.2 | 2.61 |
| B | STY/MATS/TMPTA (80/15/5) | 6.8 | 1.09 |
| C | BA/MATS/TMPTA (80/15/5) | 6.9 | 1.06 |
| D | MMA/MATS/TMPTA (80/15/5) | 5 & 18* | 1.04 |
| E | BA/GMA/TMPTA (75/20/5) | 8.9 | 1.16 |
| F | PPGMEA260/MATS/TMPTA (80/10/10) | 5.6 | 1.35 |
| G | PPGMEA260/MATS/TMPTA (80/10/10) | 10 | 1.17 |
| H | PPGMEA260/MATS/TMPTA (80/15/5) | 7.8 | 1.41 |
| I | STY/MATS/TMPTA (65/30/5) | 6.4 | 1.21 |
| J | STY/MATS/TMPTA (45/50/5) | 5.8 | 1.22 |
| K | BA/MATS/TMPTA (65/30/5) | 7 | 1.15 |
| L | BA/MATS/TMPTA (45/50/5) | 7.5 | 1.72 |
| M | STY/MATS/PPGMEA260/TMPTA (64/30/5/1) | 5.2 | 1.25 |
| N | STY/MATS/PPGMEA260/TMPTA (55/30/5/10) | 8.9 | 0.4 |
| O | MMA/MATS/PPGMEA260/TMPTA (64/30/5/1) | 8.1 | 1.05 |
| P | MMA/MATS/PPGMEA260/TMPTA (55/30/5/10) | 32 | 1.16 |
| Q | PPGMEA260/TMPTA (80/20) | 6.2 | 0.5 |
| R | 50 (MMA/MATS 50/50) // 50 (MMA/MATS/TMPTMA 80/15/5) | 7.5 & 26* | 1.66 |
| S | STY/MATS/PPGMEA260/TMPTA (64/30/5/1) | 7.3 | 0.32 |
| T | 75 (MMA/MATS/PPGMEA260/TMPTA 60/30/5/5) // 25 | 9.4 | 0.31 |
| | (MMA/MATS/PPGMEA260) | | |
| U | 75 (MMA/MATS/PPGMEA260) // 25 | 17 | 1.83 |
| | (MMA/MATS/PPGMEA260/TMPTA 60/30/5/5) | | |
| V | 25 (MMA/MATS/PPGMEA260/TMPTA 60/30/5/5) // 75 | 10.7 | 0.11 |
| | (MMA/MATS/PPGMEA260) | | |
| W | 25 (MMA/MATS/PPGMEA260) // 75 | 8.9 | 0.9 |
| | (MMA/MATS/PPGMEA260/TMPTA 60/30/5/5) | | |
| X | HEMA/TMPTA (95/5) | — | 0.83 |
| Y | MMA/MAA/TMPTA (84/15/10 | — | 1.1 |
| Z | STY/MAA/PPGMEA260/HEMA/TMPTA (49/30/5/15/1) | — | 1.75 |
| AA | MMA/MAA/HEMA/TMPTA (65/20/10/5) | — | 2.19 |
| BB | MATS/HEMA/TMPTA (30/65/5) | — | 0.93 |
| CC | AAEM/HEMA/TMPTA (30/65/5) | — | 1.5 |

*= bimodal

The above data clearly show that the adhesion of an epoxy prepreg to copper can be improved by the use of the present adhesion promoting compositions containing one or more polymeric particles.

### EXAMPLE 3

The procedure of Example 2 is repeated except that after the foil is contacted with the adhesion promoting composition containing PNPs it is then contacted with a solvent-less epoxy composition containing 0.4 wt % of a wetting agent, 1.6 wt % of a thermal acid generator, 44 wt % of a C₁₀ diepoxide compound, 10 wt % of a melamine cross-linking agent, and 44 wt % of an oligomeric epoxy-diene. The solvent-less epoxy composition is a liquid and is applied on the surface of the adhesion promoting composition layer. A size 5 draw down bar is used to form a uniform coating of the solvent-less epoxy composition on the adhesion promoting composition layer. The solvent-less epoxy composition is then cured for 10 minutes at 90° C., the temperature than being ramped to 160° C. for 50 minutes in a conventional oven. The epoxy composition is cured until it is tack-free. An epoxy prepreg material (FR 406 prepreg) is then laminated to the surface of the cured epoxy composition following the procedure of Example 2.

The adhesion of the copper foil to the epoxy prepreg is determined according to the procedure of Example 2. PNPs evaluated are reported in Table 1 along with the peel strengths determined. The control sample is copper foil coated with the solvent-less epoxy composition prior to lamination and does not contain a layer of the present adhesion promoting composition. The mean particle size reported is the mean particle diameter as determined by light scattering. The adhesion promoting compositions used are 15% solids.

TABLE 2

| | | Mean Particle | Peel Strength |
|---|---|---|---|
| Sample | PNP | Size (nm) | (lbf-in) |
| Control | None | — | 3.5⁺ |
| DD | 2-EHA/DVB/GMA (90/5/5) | 3.2 | 2.5 |
| EE | STY/MATS/TMPTA (80/15/5) | 6.8 | 3.4 |
| FF | BA/MATS/TMPTA (80/15/5) | 6.9 | 2.9 |
| GG | MMA/MATS/TMPYA (80/15/5) | 5 & 18* | 3.3 |
| HH | BA/GMA/TMPTA (75/20/5) | 8.9 | 1.6 |
| II | PPGMEA260/MATS/TMPTA | 5.6 | 2.6 |
| | (80/10/10) | | |
| JJ | PPGMEA260/MATS/TMPTA | 10 | 2.4 |
| | (80/10/10) | | |
| KK | PPGMEA260/MATS/TMPTA | 7.8 | 2.3 |
| | (80/15/5) | | |
| LL | STY/MATS/TMPTA (65/30/5) | 6.4 | 3.8 |
| MM | STY/MATS/TMPTA (45/50/5) | 5.8 | 3.6 |
| NN | BA/MATS/TMPTA (65/30/5) | — | 3.8 |
| OO | BA/MATS/TMPTA (45/50/5) | — | 3.4 |

*= bimodal;
+= average value

These data show that the present adhesion promoting composition can be used with a solvent-less epoxy composition to improve the adhesion of an epoxy prepreg to a copper foil.

### EXAMPLE 4

The procedure of Example 2 is repeated except that the concentration of the PNPs in the adhesion promoting composition, as measured by percent solids, is varied. The results are reported in Table 3. The control is bare copper foil laminated to the epoxy prepreg without the use of the present adhesion promoting compositions.

TABLE 3

| | | Percentage | Peel Strength |
|---|---|---|---|
| Sample | PNP | Solids | (lbf-in) |
| Control | None | — | 0.9 |
| PP | MMA/MATS/PPGMEA260/ | 1 | 0.34 |
| | TMPTA (64/30/5/1) | | |
| QQ | MMA/MATS/PPGMEA260/ | 5 | 0.31 |
| | TMPTA (64/30/5/1) | | |
| RR | MMA/MATS/PPGMEA260/ | 10 | 0.34 |
| | TMPTA (64/30/5/1) | | |
| SS | MMA/MATS/PPGMEA260/ | 15 | 3.39 |
| | TMPTA (64/30/5/1) | | |

### EXAMPLE 5

The procedure of Example 2 is repeated except that a polyimide prepreg is used.

### EXAMPLE 6

The procedure of Example 2 is repeated except that the adhesion promoting composition is a blend of PNPs and a solvent-less epoxy composition. The adhesion promoting composition is prepared by combining 0.4 wt % of a wetting agent, 1.6 wt % of a thermal acid generator, 44 wt % of a C₁₀ diepoxide compound, 10 wt % of a melamine cross-linking agent, and 44 wt % of an oligomeric epoxy-diene with an amount of PNPs. The amounts of PNP in the adhesion promoting composition vary from 1 to 40 wt %, based on the total weight of the composition. Following lamination to an epoxy prepreg, the peel strengths are determined according to the procedure of Example 2. The peel strengths are expected to be significantly higher than those obtained with bare copper foil.

### EXAMPLE 7

The procedure of Example 6 is repeated except that a polyimide prepreg is used.

### EXAMPLE 8

The procedure of Example 2 is repeated except that a conventional soldermask is used instead of the epoxy prepreg material.

1. A method for manufacturing a printed circuit board comprising the steps of: contacting a metal surface of a printed circuit board substrate with an adhesion promoting composition comprising polymeric particles having a mean particle diameter of 1 to 50 nm and comprising, as polymerized units, at least one multiethylenically unsaturated monomer and at least one ethylenically unsaturated monomer; and contacting the adhesion promoting composition with an organic polymeric material.

2. The method of claim 1, wherein the metal is chosen from one or more of copper, aluminum, tin, silver, gold, lead, zinc, nickel and alloys of any of the foregoing.

3. The method of claim 1, wherein the polymeric particles further comprise one or more nitrogen-containing moieties.

4. The method of claim 1, wherein the metal comprises circuit traces.

5. The method of claim 1, wherein the polymeric particles comprise from 0.1 to 100 weight percent, based on a total dry weight of the adhesion promoting composition.

6. The method of claim 1, wherein the contacting step comprises one or more of dip-coating, spray-coating, wash-coating, die-coating, curtain-coating and roller-coating.

7. The method of claim 1, wherein the organic polymeric material is chosen from one or more of epoxy resins, polyimide resins, polyester resins, polyarylene resins, polyarylene-ether resins, polybutadiene resins, bismaleimide-triazine resins, polyether-imide resins, cyanate ester resins, polyisoprene resins, and acrylate resins.

8. The method of claim 1, wherein the metal further comprises one or more of a resistor material and a capacitor material.

9. A printed circuit board comprising a metal surface and a layer of an adhesion promoting composition on at least a portion of the metal surface, the adhesion promoting composition comprising polymeric particles having a mean particle diameter of 1 to 50 nm and comprising, as polymerized units, at least one multiethylenically unsaturated monomer and at least one ethylenically unsaturated monomer.

10. The printed circuit board of claim 9 further comprising at least one dielectric material adhered to the adhesion promoting composition layer.
